(19) United States
(12) Patent Application Publication
(10) Pub. No.: US 2016/0104379 A1
(43) Pub. Date: Apr. 14, 2016

(54) ANTI-COLLISION SYSTEM FOR AN AGRICULTURAL VEHICLE WITH AUTOMATIC DETECTION OF THE DIMENSIONS OF A LOAD

(71) Applicant: Deere & Company, Moline, IL (US)

(72) Inventor: MARCO REINARDS, GRUENSTADT (DE)

(21) Appl. No.: 14/971,126

(22) Filed: Dec. 16, 2015

Related U.S. Application Data
(63) Continuation of application No. PCT/EP2014/063847, filed on Jun. 30, 2014.

(30) Foreign Application Priority Data
Jul. 3, 2013 (DE) 102013011089.0

(51) Int. Cl. G08G 1/16; A01D 75/18

(52) U.S. Cl. CPC G08G 1/165; A01D 75/185

(57) ABSTRACT

An anti-collision system for an agricultural vehicle includes a first sensor for detecting the dimensions of a clear-space profile available in front of the vehicle in the direction of travel, a second sensor for detecting the dimensions of a load moved by the vehicle, and a processing device which compares the dimensions of the clear-space profile with the dimensions of the load on the basis of the signals of the first and second sensors and outputs a warning signal if a collision between the load and a boundary of the clear-space profile is imminent.

### RELATED APPLICATIONS

This application is a continuation application of International Application Serial No. PCT/EP2014/063847, which has an international filing date of Jun. 30, 2014, and which claims the benefit of German Application Ser. No. 102013011089.0, filed on Jul. 3, 2013. The disclosures of these aforementioned applications are hereby expressly incorporated by reference in their entirety.

### FIELD OF THE DISCLOSURE

The present disclosure relates to an anti-collision system for an agricultural vehicle.

### BACKGROUND

A variety of tasks may be performed in an agricultural operation. Therefore, a universally applicable vehicle is used, generally a tractor, which can be used for mounting or towing a variety of loads depending on the specific task. Since well-trained, experienced personnel is not always available, semi-skilled workers are often employed. There is accordingly a certain risk of accident, e.g. when driving on narrow field roads, since the load is not in the driver's field of view and can protrude from the lateral or vertical dimensions of the tractor to different extents. This may be the case, for example, with cultivation implements, hay-baling implements or fillable trailers. The dimensions may even change while working and, as temporary help, the driver may not be well-acquainted with the dimensions of the load.

Anti-collision sensors for motor vehicles are known in the prior art, in which the profile of the vehicle to be protected is known and permanently programmed, or can be derived from the placement of the sensors. Such sensors are not well-suited to agricultural vehicles, however, which may carry different-sized loads at the rear.

A conventional traction vehicle for transporting aircraft or barges may include an optical sensor, designed in particular as a camera system, that is oriented toward the load and the signal of which is used for automatic detection of the load. The load can be driven without collisions in this manner past obstacles that are at positions drawn on a map. Due to the differences of loads and the necessity of first capturing a travel path on a map, this conventional procedure is not suited for agricultural applications, for which the obstacles are often moving, such as opposing traffic.

### SUMMARY

In this disclosure, an embodiment is provided of an anti-collision system for an agricultural vehicle. In this embodiment, the anti-collision system for an agricultural vehicle includes a first sensor for detecting the dimensions of a clearance profile available in front of the vehicle in the direction of travel, a second sensor for detecting the dimensions of a load moved by the vehicle, and a processing device that is connected to the first and the second sensors and compares the dimensions of the clearance profile to the dimensions of the load on the basis of the signals of the first sensor and the second sensor, and outputs a warning signal if a collision between the load and a boundary of the clearance profile is imminent.

In this manner, the dimensions of the load are determined by the second sensor and compared to the dimensions of the clearance profile determined by means of the first sensor, i.e. the vertical cross-sectional area available in front of the vehicle in the direction of travel. If there is a threat of a contact between the load and the boundaries of the clearance profile, a warning signal is output. The sensors can each detect the dimensions of the clearance profile and the load in the horizontal and vertical directions.

The warning signal can be supplied to a speed setting device of the vehicle in order to stop the vehicle in the event that a collision between the load and a boundary of the clearance profile is imminent. Alternatively or additionally, a steering device of the vehicle can be triggered for a collision-averting steering movement.

These sensors can each comprise stereo cameras with image processing systems and/or scanning laser range finders and/or PMD cameras and/or ultrasonic range finders.

### BRIEF DESCRIPTION OF THE DRAWINGS

The above-mentioned aspects of the present disclosure and the manner of obtaining them will become more apparent and the disclosure itself will be better understood by reference to the following description of the embodiments of the disclosure, taken in conjunction with the accompanying drawings, wherein:

FIG. 1 shows a side view of an agricultural tractor having a towed load and an anti-collision system; and

FIG. 2 shows a screen of a user interface.

### DETAILED DESCRIPTION

The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure.

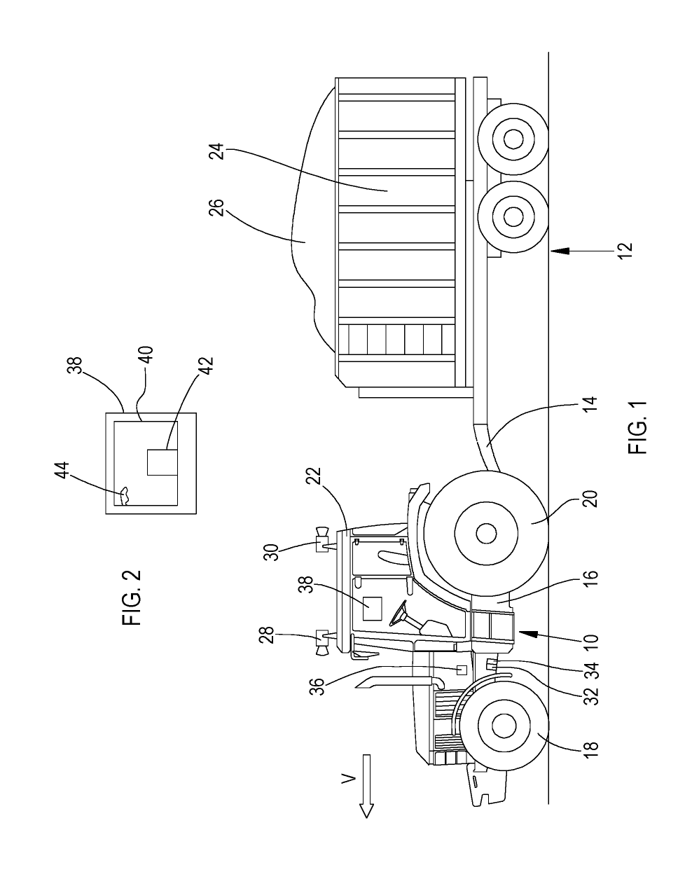

FIG. 1 shows an agricultural vehicle 10 in the form of a tractor that is towing a load 12 in the form of a silage transport wagon on a drawbar 14. The vehicle 10 includes a vehicle frame 16 having a plurality of ground-engaging mechanisms such as steerable front wheels 18 and drivable rear wheels 20, as well as a cab 22 with a workplace for an operator. The drawbar 14 is detachably coupled to the frame 16 at the rear by means of a hitch (not shown).

The vertical dimensions of the load 12, which is approximately as high in the unloaded state as the roof of the cab 22, can vary during operation if the loading container 24 of the load 12 is loaded above the upper edges thereof, as can occur when harvesting silage with a forage harvester that transfers the silage into the loading container 24, so that large hills 26 of crop are formed that protrude above the upper edge of the loading container 24.

An anti-collision system according to the present disclosure is provided in order to avoid collisions between the load 12 and an obstacle, e.g. a bridge or low-hanging branches, that may be present in front of the vehicle 10 in the direction of travel V. The system includes a first sensor 28, a second sensor 30 and a processing unit 32. The sensors 28, 30 are mounted on the roof of the cab 22.

The first sensor 28 is constructed in this case as a stereo camera having two cameras arranged side by side transversely to the direction of travel V, and an image processing system, which can also be contained in the processing unit 32. The image processing system continuously outputs a signal that contains information regarding the clearance profile available in front of the vehicle, i.e. the lateral distance of any detected obstacles from the central longitudinal plane of the vehicle 10, and the vertical distance of these obstacles from the ground.

The second sensor 30 is likewise constructed in this case as a stereo camera having two cameras arranged side by side transversely to the direction of travel V, and an image processing system that can also be contained in the processing unit 32. The image processing system continuously outputs a signal that contains information regarding the dimensions of the load 12, i.e. the lateral distance of the two lateral boundaries of the load 12 from the longitudinal central plane of the vehicle 10, and the vertical distance of the upper boundary of the load from the ground.

The electronic processing device 32 continuously compares the horizontal distances between any obstacles detected in the signal from the first sensor 28 and the longitudinal central plane of the vehicle 10 on both sides to the lateral distances of the two lateral limits of the load from the longitudinal central plane of the vehicle 10. If the front wheels 18 and/or the drawbar 14 are not in a straight-ahead position, the kinematics of the vehicle 10 having the load 12 and the distance between the obstacle and the vehicle in the travel direction V can also be taken into consideration in order to improve the precision of the comparison. In this regard, the reader is referred to in the disclosure of German Patent Application DE 102008057027A1, which is hereby incorporated by reference in this application. In a simple embodiment, on the other hand, the distances detected by the sensors 28 and 30 in both lateral directions are simply compared.

The processing device 32 analogously compares the vertical position of an obstacle to the vertical position of the upper boundary of the load in operation. A rising or falling ground profile in the travel direction V can be detected with the first sensor 28 and taken into account by the processing device 32 if desired.

If there is a risk that the load may collide with the obstacle in the horizontal and/or vertical direction, the processing device 32 outputs a warning signal, preferably in the form of an acoustic or visual signal, to an operator in a cab 22 via an operator interface 38. Alternatively or additionally, a speed setting device 34 of the vehicle 10 (influencing the speed of the internal combustion engine, the transmission ratio, or the brakes) can be prompted by the processing device 32 in this case to stop the vehicle 10 by an appropriate signal, or a steering device 36 can be actuated by a suitable signal for collision avoidance.

FIG. 2 shows the display device 40 of a user interface 38 arranged in the cab 22. The profile 42 of the load 12 detected by the second sensor 30 and any obstacles 44 detected by the first sensor 28, a branch in this case, are shown schematically. If a collision is imminent, the relevant position can be highlighted in color.

The horizontal and vertical dimensions of the vehicle 10 are preferably also programmed into the processing device 32. The processing device 32 also compares these dimensions to the position of any obstacle detected by the first sensor 28, and in the event of an imminent collision outputs the above-described warning signal, stop signal to the speed setting device 34, or steering signal to the steering device 36.

If the load 12 is positioned at the front side of the vehicle 10, e.g. a front mower or soil compactor, the second sensor 30 can also be oriented forward by being rotated by 180° manually or with a motor. Alternatively or additionally, the first sensor 28 takes on this task in such a case.

The signals of the first sensor 28 can additionally be used for detecting traffic signs, road markers and boundaries, etc., and for providing signals for the speed setting device 34 or steering device 36 in order to relieve the operator.

While embodiments incorporating the principles of the present disclosure have been described hereinabove, the present disclosure is not limited to the described embodiments. Instead, this application is intended to cover any variations, uses, or adaptations of the disclosure using its general principles. Further, this application is intended to cover such departures from the present disclosure as come within known or customary practice in the art to which this disclosure pertains and which fall within the limits of the appended claims.

1. Anti-collision system for an agricultural vehicle, comprising:
a first sensor for detecting the dimensions of a clearance profile available in front of the vehicle in the travel direction;
a second sensor for detecting the dimensions of a load moved by the vehicle; and
a processing device connected to the first sensor and the second sensor, the processing device operably controlled to compare the dimensions of the clearance profile to the dimensions of the load based on signals from the first sensor and the second sensor, and to output a warning signal if a collision between the load and a boundary of the clearance profile is imminent.

2. Anti-collision system of claim 1, wherein the first and second sensors each detect the dimensions in horizontal and vertical directions.

3. Anti-collision system of claim 1, wherein the warning signal is supplied to a speed setting device of the vehicle in order to stop a movement of the vehicle if a collision between the load and a boundary of the clearance profile is imminent.

4. Anti-collision system of claim 1, wherein the processing device is connected to a steering device of the vehicle for actuating the steering device for a collision-avoiding steering movement if a collision is imminent.

5. Anti-collision system of claim 1, wherein the first and second sensors each comprise stereo cameras with image processing systems, scanning laser range finders, PMD cameras, or ultrasonic range finders.

6. Anti-collision system of claim 1, wherein the processing device is connected to a user interface, and the processing device and the user interface are designed to display a profile of the load detected by the second sensor and the obstacles detected by the first sensor on a display device of the user interface.

7. Anti-collision system of claim 6, wherein the processing device and the user interface are designed to emphasize a point at which a collision is imminent in color on the display device.

8. Anti-collision system of claim 1, wherein the dimensions of the load vary during operation of the vehicle.

9. Anti-collision system of claim 1, wherein the load is positioned on a front side or a rear side of the vehicle.

10. An agricultural vehicle movable in a travel direction, comprising:
a frame for supporting a plurality of ground-engaging mechanisms;
an operator cab mounted on the frame;
an anti-collision system including:
a first sensor for detecting dimensions of a clearance profile available in front of the vehicle in the travel direction;
a second sensor for detecting the dimensions of a load moved by the vehicle, the load being removably coupled to the vehicle; and
a processing device connected to the first sensor and the second sensor, the processing device operably controlled to compare the dimensions of the clearance profile to the dimensions of the load based on signals from the first sensor and the second sensor, and to output a warning signal if a collision between the load and a boundary of the clearance profile is imminent.

11. The agricultural vehicle of claim 10, wherein the first and second sensors each detect the dimensions in horizontal and vertical directions.

12. The agricultural vehicle of claim 10, wherein the warning signal is supplied to a speed setting device of the vehicle in order to stop a movement of the vehicle if a collision between the load and a boundary of the clearance profile is imminent.

13. The agricultural vehicle of claim 10, wherein the processing device is connected to a steering device of the vehicle for actuating the steering device for a collision-avoiding steering movement if a collision is imminent.

14. The agricultural vehicle of claim 10, wherein the first and second sensors each comprise stereo cameras with image processing systems, scanning laser range finders, PMD cameras, or ultrasonic range finders.

15. The agricultural vehicle of claim 10, wherein the processing device is connected to a user interface, and the processing device and the user interface are designed to display a profile of the load detected by the second sensor and the obstacles detected by the first sensor on a display device of the user interface.

16. The agricultural vehicle of claim 15, wherein the processing device and the user interface are designed to emphasize a point at which a collision is imminent in color on the display device.

17. The agricultural vehicle of claim 10, wherein the dimensions of the load vary during operation of the vehicle.

18. The agricultural vehicle of claim 10, wherein the load is positioned on a front side or a rear side of the vehicle.
